(19) United States
(12) Patent Application Publication
(10) Pub. No.: US 2009/0111189 A1
(43) Pub. Date: Apr. 30, 2009

(54) ORGANIC AND INORGANIC MERCURY DETECTION

(75) Inventor: Stuart SCHROEDER, Vegreville (CA)

Correspondence Address: EDWARD YOO C/O BENNETT JONES, 1000 ATCO CENTRE, 10035 - 105 STREET, EDMONTON, ALBERTA, AB, T5J3T2, CA

(73) Assignee: ALBERTA RESEARCH COUNCIL INC., Edmonton (CA)

(21) Appl. No.: 12/259,121

(22) Filed: Oct. 27, 2008

Related U.S. Application Data
(60) Provisional application No. 60/982,943, filed on Oct. 26, 2007.

(51) Int. Cl. G01N 30/74; G01N 30/00

(52) U.S. Cl. 436/81; 436/161; 422/69

(57) ABSTRACT

An apparatus and method for the detection and quantitation of metals and metalloids in a sample by derivatization are provided. In particular, the apparatus and method relates to analysis of mercury in a sample by derivatization of the inorganic and organic mercury species into elemental mercury and organo-mercury hydrides using sodium borohydride.

### FIELD OF INVENTION

The present invention relates to an apparatus and method for the detection and quantitation of metals and metalloids in a sample by derivatization. In particular, the apparatus and method relates to analysis of mercury in a sample by derivatization of the inorganic and organic mercury species into elemental mercury and organo-mercury hydrides using sodium borohydride.

### BACKGROUND OF THE INVENTION

The potential presence of methyl mercury (CH₃—Hg⁺) in surface water has created a need for analytical techniques capable of detecting sub-nanograms per litre concentrations. Methyl mercury is the specific form of mercury that bioaccumulates most readily in mammals and is the most toxic species of mercury found in environmental samples. Because of the increased awareness of environmental mercury contamination, and the understanding that the production and accumulation of CH₃—Hg⁺ drives the contamination problem, there is a need for a reliable analytical method for detection and quantitation of CH₃—Hg⁺.

Volatile derivatives of inorganic and organic mercury are created by reacting the mercury species with a derivitization reagent in a reaction vessel, or in a bubbler, and these volatile derivatives are collected on a suitable trapping device, such as a cryogenic trap. The most common derivitization reagent is tetraethyl borate. A typical analysis involves adding the environmental solution sample to the reaction vessel, adding the derivitization reagent (such as tetraethyl borate or sodium borohydride) and bubbling an inert gas through the solution. The inert gas collects the volatile mercury species and carries them to the trapping device. This allows for pre-concentration and very low detection limits (typically less than 0.1 ng/L).

Fillippelli et al. has described a derivatization procedure of methyl mercury chloride using sodium borohydride (NaBH₄) that resulted in a volatile and relatively stable (t_{1/2}˜2 h.) methyl mercury hydride species. The analytical apparatus consisted of a purge and trap unit linked to a gas chromatograph (GC), in line with a Fourier Transform Infra-Red (FTIR) spectrometer. After derivatization, the reaction mixture was purged for 5 minutes to purge the methyl-mercury-hydride species. The sample is purged with nitrogen, and volatile compounds are concentrated in a cold-trap. The trap is heated and the compounds separated on a GC column, followed by analysis by FTIR spectrometer. In addition, the mercury derivatization procedure as described by Fillippelli was used by Quevauviller et al. in their detection and analysis of mercury.

Puk et al. had developed a method for mercury (II), monomethyl mercury cation, dimethylmercury and diethylmercury by hydride generation volatization, trapping and separation on a chromatographic column and detection by atomic absorption spectrophotometry in a heated quartz furnace. The hydride generation conditions were optimized, however, utilizing a device analogous to a ‘bubbler’, where the sodium borohydride was added to a reaction vessel that allowed the mercury species to volatize and be trapped prior to separation and detection. Ritsema et al. have described a similar analytical setup with a reaction vessel for hydride generation, followed by cryo-trapping and atomic fluorescence detection. The derivatized mercury hydride species were removed from the reaction vessel by an argon stream, followed by cryogenic trapping.

Tseng et al. disclosed extraction of mercury species, specifically inorganic mercury and methyl-mercury, from fish tissues by use of microwave-assisted digestion in an alkaline solution. This technique was used in combination with an on-line interface of hydride generation, cryogenic trapping, gas chromatography, electrothermal atomic absorption spectrometric detection (D-CT-GC-ETAAS). After extraction, derivatization is performed using a peristaltic pump that pumps NaBH₄ into the reaction vessel (250 mL flask), in which the purging steps take place. Similarly, de Diego et al. have used a similar set-up when studying the effects of NaCl interference in mercury determination using either hydride generation or ethylation techniques.

Qvarnström et al. have described an alternative system utilizing high pressure liquid chromatography (HPLC) for the detection of inorganic mercury and methyl-mercury utilizing a flow injection high-performance liquid chromatography cold vapour atomic absorption spectrometry (FI-HPLC-CV-AAS). The samples were first enriched by a pre-concentration column. The mercury species were separated on a HPLC column, followed by reaction in with NaBH₄ in a 200 μL coil to form the mercury hydride species that ends in a gas-liquid separator, which is purged with argon to carry the volatile mercury-hydride species through a quartz cell and a Nafion dryer, prior to entering the cuvette, where analysis by AAS is performed.

Each of the prior art methods known to the applicants involve the use of a bubbler or reaction vessel. The use of a bubbler or reaction vessel causes a time delay in the analysis. An instrument or method where the reaction vessel or bubbler is eliminated would allow for rapid analysis of the mercury species, and would greatly assist in instrument automation.

### SUMMARY OF THE INVENTION

In one aspect, the invention relates to a method for analysis of a stable and derivatizable analyte, the method comprising the steps of:
(a) contacting the analyte with a derivatizing agent to generate a volatile derivatized-analyte;
(b) separation of the derivatized-analyte into a gas phase;
(c) separation of the derivatized-analyte using a chromatographic method; and
(d) detection of the derivatized analyte with an appropriate detector.
   In one embodiment, the analyte is contacted with the derivatizing agent in a flow-through connector, such as a T-connector.

In one embodiment, the analyte comprises a mercury species, and the detector comprises an atomic fluorescence detector.

In one embodiment, the method further comprises the step of pre-concentrating the volatile species in a trapping device, prior to separation in a gas chromatograph. The trapping device may comprise a carbo-trap or a cryotrap.

In another aspect, the invention comprises a device for analysis of a stable and derivatizable analyte, comprising:
(a) a flow-through mixer for combining an analyte flow and a derivatizing agent flow;
(b) a phase separator having an inlet for the combined analyte/derivatizing agent flow, a carrier gas inlet, and a carrier gas outlet;
(b) a gas chromatograph (GC) adapted to receive the carrier gas outlet flow of the phase separator;
(c) a detector connected to the gas chromatograph.

In one embodiment, the flow-through mixer comprises a T or a Y-connector adapted for combining the analyte flow and derivatizing agent flow.

In one embodiment, the device comprises means for collecting, and optionally pre-concentrating, the derivatized-analyte from the phase-separator, prior to separation by the gas chromatograph.

In another aspect, the invention relates to a method of analysis of inorganic and organic mercury in a sample, the method comprising the steps of:
(a) derivatization of mercury species in a sample using a reducing agent in a flow-through device, to create volatile mercury derivatives;
(b) separation of the volatile mercury derivatives from the derivatization reagent-sample mixture using a carrier gas;
(c) separation of the derivatized mercury species in the carrier gas by gas chromatography; and
(d) detection of the derivatized mercury species.

### BRIEF DESCRIPTION OF THE FIGURES

FIG. 1 shows a schematic representation of a system for mercury and methyl-mercury analysis.

FIG. 2A shows a sample chromatogram of an acid blank and 25 and 50 ng/L Hg and Me—Hg while FIG. 2B shows a sample chromatogram of inorganic mercury, methyl mercury and ethyl mercury.

FIG. 3 shows a calibration curve for inorganic mercury analysis.

FIG. 4 shows a calibration curve for methyl mercury analysis.

FIG. 5 shows another calibration curve for inorganic mercury analysis.

FIG. 6 shows another calibration curve for methyl mercury analysis.

### DETAILED DESCRIPTION OF THE INVENTION

The present invention relates to a method and apparatus for analysis of a stable and derivatizable analyte. When describing the present invention, all terms not defined herein have their common art-recognized meanings. To the extent that the following description is of a specific embodiment or a particular use of the invention, it is intended to be illustrative only, and not limiting of the claimed invention. The following description is intended to cover all alternatives, modifications and equivalents that are included in the spirit and scope of the invention, as defined in the appended claims.

As used herein, “volatile” means that the element or compound is gaseous or vaporizes readily at the pressure and temperature conditions presented.

In the present invention, flow injection analysis allows for a robust and efficient method of forming volatile analyte derivatives without the need of a bubbler or reaction vessel. As used herein, flow injection analysis is defined as the combination of two flowing solution streams in a flow-through device, a sample stream which contains the analyte to be measured or detected, and a reagent stream containing a reagent. When the reagent combines with the sample, derivitization of the analyte occurs nearly instantaneously to create volatile derivates.

A flow-through device is exemplified by a T-connector, or a Y-connector, which simply combines two fluid flows in a single tube. It differs from a reaction vessel or a bubbler in that there is no residence time in the device, other than the time necessary to flow-through the device at the designated flow rate. Also, a flow-through device differs from a reaction vessel or bubbler in that it prohibits the gaseous interaction of solution chemistry until the flow reaches the gas/liquid phase separator. In other words, there is substantially no gaseous headspace within the device.

Elimination of the reaction vessel or bubbler allows for rapid analysis of an analyte. In one embodiment, the analyte comprises mercury species. This rapid analysis is suitable for instrument automation. In addition, the use of the flow injection technology allowed for separation of the mercury species without the use of a carbon or organic based trap for organic mercury or a gold trap for elemental mercury, which is another advantage of the current invention and assists in instrument automation and would further reduce analysis time.

The combined flow passes into a phase separator where an inert carrier gas is introduced. The volatile derivatives formed by the analyte and the reagent report to the gaseous phase, and is carried by the carrier gas. If necessary, gentle heat may be applied in the phase separator to encourage vaporization of the volatile analyte derivatives.

In one embodiment, the analyte comprises mercury species and the reagent comprises a reducing agent, which may be, for example, sodium borohydride. Inorganic mercury reacts with sodium borohydride and is reduced to elemental mercury. Elemental mercury is volatile and is therefore transported with the carrier gas. Organic mercury species are converted to organic mercury hydrides by reacting with sodium borohydride. For example, in this way methyl mercury is converted to methyl mercury hydride and ethyl mercury is converted to ethyl mercury hydride. Dimethyl mercury and diethyl mercury are non-reactive with respect to sodium borohydride and are naturally volatile, therefore, they are transported with the carrier gas in their original state.

Reagents may comprise other reducing or derivitization agents including, without limitation, stannous chloride, sodium tetraethylborate or tetrapropylborate, sodium cyanotrihydroborate (III), sodium (or potassium) tetrahydroborate (NaBH₄ or KBH₄). These agents convert ionic mercury species to more volatile neutral non-ionic mercury. Specifically, these agents react with inorganic mercury to form elemental mercury, and with organic mercury species to form volatile organic mercury derivatives.

In alternative embodiments, the formation of a volatile metal derivative is accomplished not by flow injection analysis but by subjecting the sample stream to electrochemical hydride generation or photo-induced chemical vapour generation. (See Pyell et al. and C. Zheng et al.)

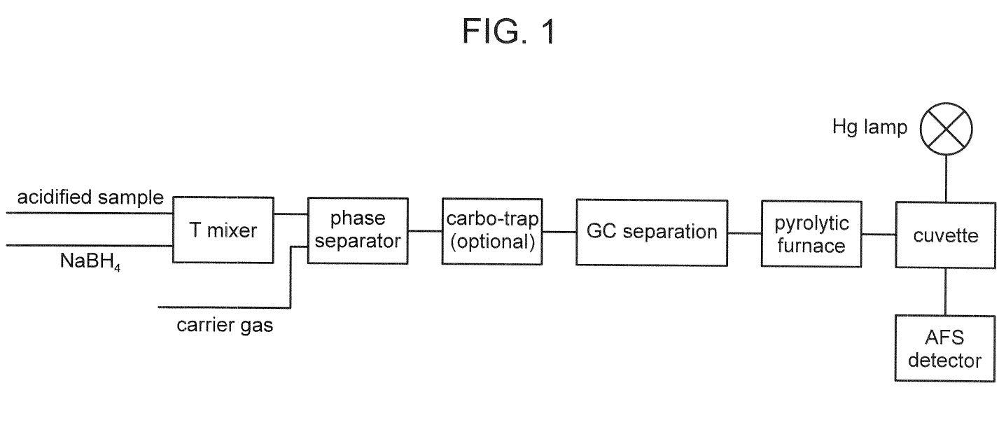

In flow injection analysis, the two solution streams can be pumped with a peristaltic pump or a piston pump. Their relative flow rates are controlled by the size of the pump tubing for peristaltic pumping and the speed and size of the piston in piston pumping. The combination of the two streams can be achieved with a simple “T” fitting, as shown in FIG. 1. Upon mixing, the following reaction takes place for elemental and methyl mercury respectively:

Hg²⁺+2NaBH₄+6H₂O→Hg⁰+7H₂+2H₃BO₃+2Na⁺

MeHg⁺+NaBH₄+3H₂O→MeHgH+3H₂+H₃BO₃+Na⁺

An equivalent reaction will occur for ethyl mercury.

The combined streams are transported to a phase separator where the reaction solution is drained and the carrier gas is introduced to transport volatile mercury species to the trapping device or sample loop. Alternatively, the mixing of the two streams could take place directly inside the phase separator.

The carrier gas flowing from the phase separator may be directed to a trapping device in order to pre-concentrate the volatile species. The trapping device may comprise a carbo-trap which concentrates organic mercury species, or a cryogenic trap, which concentrates all volatile species in the carrier gas flow.

Alternatively, in one embodiment, a trapping pre-concentration step is not required, and sufficient detection limits of inorganic and methyl mercury can also be achieved by using a passive sample loop as the gas collection technique. The passive sample loop may comprise an empty inert tube with a small internal volume, typically about 10 mL or less, which delivers a known and reproducible volume of gas to the gas chromatograph.

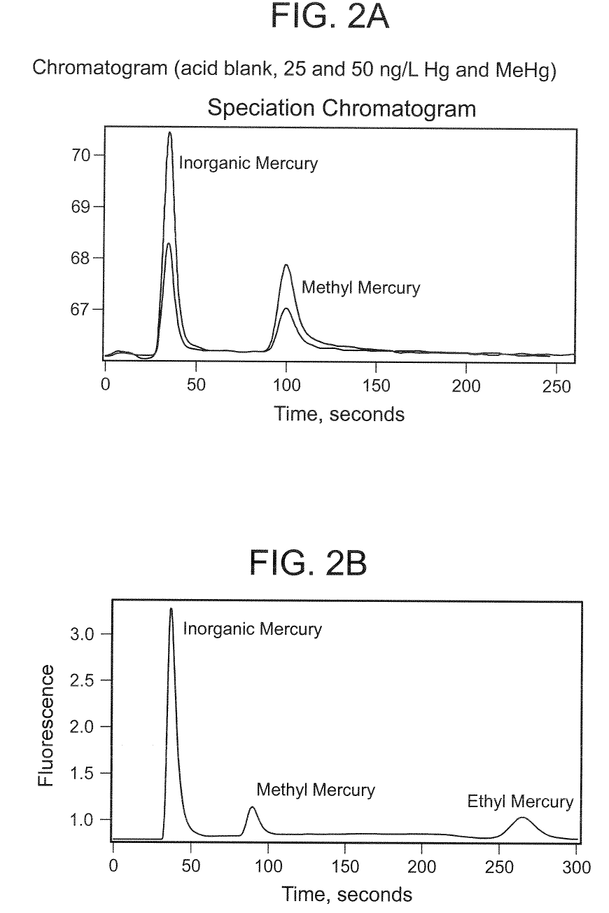

FIG. 2 discloses a sample chromatogram disclosing the analysis done using one embodiment of the current invention. In addition to separation and analysis of individual mercury species of interest, total mercury analysis can also be performed using the current invention.

In addition to trapping and analysis of mercury at low or ambient temperatures, the device can be fitted with an empty sample loop at room temperature after the phase separator for analysis of mercury and other metals. The sample loop allows for the collection of the derivatized mercury or other metals prior to separation on the gas chromatograph (GC) and may be used in place of a cryo-trap or other low temperature based trapping device.

The gas chromatograph separates the volatile species in the carrier gas using well-known chromatographic principles. The stationary phase may be a liquid or a polymer, and will cause the different volatile species to elute from the GC column at different times. Analysis of the retention times permits quantitation of the gaseous species. The gas chromatograph may comprise any form of gas chromatography device, including packed column, capillary column or multiple capillary column devices.

The separated gas output is then passed to a detector for physically detecting the separated species of interest. If the analyte of interest is mercury, then atomic fluorescence spectrometry (AFS) may be employed to detect the mercury derivatives. The separated gas output from the gas chromatograph is heated in a furnace, for example to about 800° C., and mercury species are detected using a mercury lamp, as is well known in the art.

The AFS detector identifies the GC peaks and correlates them to specific mercury species, and their retention time.

Different analytes will require different detection systems, and one skilled in the art will be able to determine a suitable detection system based on the analyte of interest.

In one embodiment, the method is automated with the goal of providing quick, efficient and accurate determinations of mercury in a sample. The method permits the simultaneous detection of inorganic and organic mercury species in the same gas chromatogram. The method provides quick results, particularly if a trapping device is not used.

Quantitation of the analyte derivatives may be accomplished using a calibration curve obtained with known control samples of the analytes in question. A linear calibration may be achieved for both methyl mercury and inorganic mercury simultaneously. The squared correlation coefficient is preferably a minimum of 0.99 which satisfies the current quality standards for methyl mercury and total mercury analysis.

### EXAMPLES

The following examples are intended to demonstrate embodiments of the present invention, and not to limit any aspect of the claimed invention.

Simultaneous detection of mercury species can be performed without the need of cyro-trapping. Chromatographic runs are currently complete in 2.5 minutes and the addition of a multicapillary column will reduce this time to less than 2 minutes. Total analysis time per sample will be less than 5 minutes and may approach 3 minutes per sample.

### Experimental Conditions:

| | |
|---|---|
| Sample Loop: | 1.0 mL, 0.72 m long, 0.052″ I.D. plastic tube |
| Oven Temperature: | 30° C. |
| Carrier Flow Rate: | 35 mL/min, Ar |
| Phase Separator: | U-Tube Design |
| Supplemental Ar Flow: | 50 mL/min |
| Dryer: | 12″ Nafion drying membrane |
| GC Column: | 15% OV-3, 60/80 CHROM WAW DMCS, |
| | 1 m × 4 mm glass |

Sodium borohydride at 15.2 g/L was pumped and combined at the T-connector with the acidified (0.5% HCl) sample solution containing the mercury species. The sodium borohydride flow rate was 5.6 mL/min and the acidified sample flow rate was 12.5 mL/min. All transfer lines were ⅛″ plastic tubing. Prior to the phase separator, a supplementary flow of Ar was provided to assist the transport of the volatile mercury species to the sample loop. Once the sample loop was filled with volatile mercury species, the Ar carrier flow was directed through the sample loop to carry the sample to the GC column. The GC column temperature was kept constant at 30 C. The gas stream exited the GC column and was directed through the pyrolytic furnace to convert all the mercury species to elemental mercury. Eluted species were then detected by atomic fluorescence.

The chromatogram in FIG. 2B was collected in a similar manner with the following exceptions. A 2.0 mL sample loop was used instead of a 1.0 mL sample loop. No Nafion drying tube, or drying of any other kind, was used. The supplemental Ar flow rate was 13 mL/min. The GC column temperature was held constant at 45 C. A commercially available gas liquid phase separator was used (model VGA-77 from Varian Inc.)

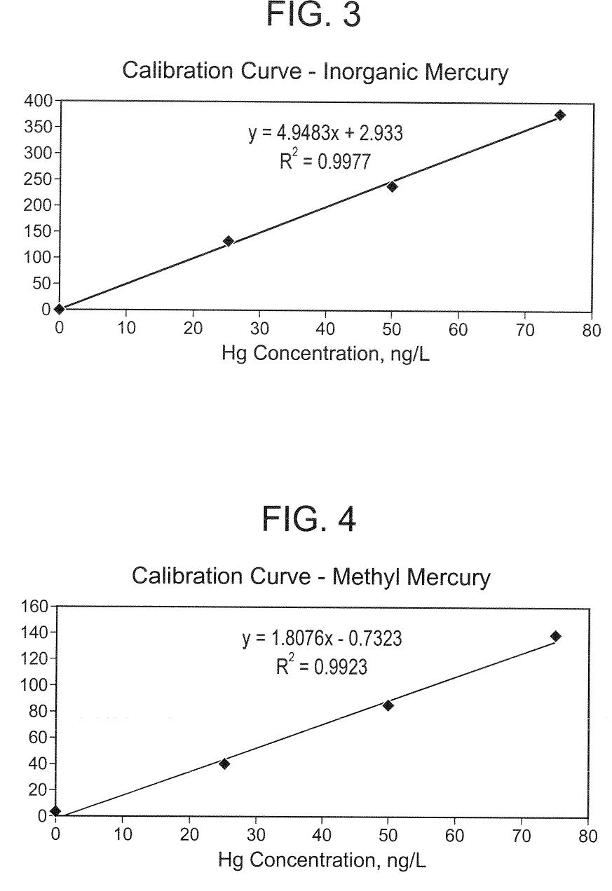

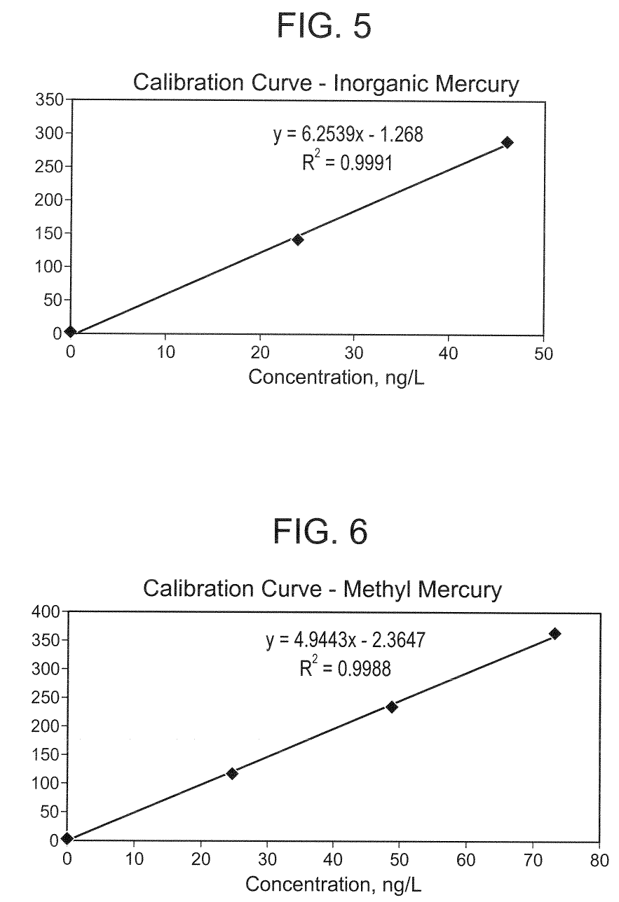

The squared correlation coefficient is preferably a minimum of 0.99 which satisfies the current quality standards for methyl mercury and total mercury analysis. These criteria were met on consecutive days (FIGS. 3-6). Calibration curves were constructed by preparing a reagent blank of 0.5% HCl and a series of inorganic and methyl mercury standards ranging in concentration from 25 to 75 ng/L. Three mercury standards were prepared. Standard 1 contained 25 ng/L inorganic mercury and 25 ng/L methyl mercury. Standard 2 contained 50 ng/L inorganic mercury and 50 ng/L methyl mercury. Standard 3 contained 75 ng/L inorganic mercury and 75 ng/L methyl mercury. All solutions contained 0.5% HCl. Calibration curves were constructed by plotting the fluorescent signal versus the mercury concentration for inorganic and methyl mercury respectively. The fluorescent signal from the peaks shown in the chromatograms were determined by baseline subtraction and peak area integration. All calibration curves show a linear response between the fluorescent signal and mercury concentration regardless of the species of mercury. Peak areas for inorganic mercury were corrected due to traces of inorganic mercury found in the methyl mercury standards. All linear calibration curves pass near the origin, showing low background contamination. The linear curves and correlation coefficients were constructed by a least-square statistical method in a commercially available software program. Signal-to-noise ratios for the data were improved through the use of lowpass digital filtering. The detection limits from the data set are 0.12 and 0.33 ng/L for inorganic mercury and methyl mercury respectively.

Repeatability tests using 50 ng/L inorganic mercury and 50 ng/L methyl mercury standards showed a relative standard deviation of 3.2% for inorganic mercury and 5.9% for methyl mercury. These statistics were generated from 8 consecutive chromatograms.

Although the invention described herein is specific to mercury hydride derivatives and a T-connector for mixing the derivatizing reagent with the analyte sample, one skilled in the art would recognize that various modifications and amendments, such as analysis of other elements, derivatizing reagents, other appropriate connectors and sample-loop modifications can be made with departing from the scope of the invention.

### REFERENCES

The following references are incorporated herein by reference (where permitted), as if reproduced herein in their entirety.
T. Stoichev, D. Amouroux, R. C. R. Martin-Doimeadios, M. Monperrus, O. F. X. Donard and D. L. Tsalev, Applied Spectroscopy Reviews 41, 591 (2006).
A. Diego, C. M. Tseng, T. Stoichev, D Amouroux and O. F. X. Donard, J. Anal. At. Spectrom. 13, 623 (1998).
R. Puk and J. H. Weber, Analytica Chimica Acta, 292, 175 (1994).
J. Qvarnström, Q. Tu, W. Frech and C Ludke, Analyst 125, 1193 (2000).
M. Filippelli, F. Baldi, F. E. Brinkman and G. J. Olson, Environ. Sci. Technol., 26(7), 1457 (1992).
R. Ritsema and O. F. X. Donard, Applied Organometallic Chemistry 8, 571 (1994).
C. M. Tseng, A. Diego, F. M. Martin, D. Amouroux and O. F. X. Donard, J. Anal. At. Spectrom. 12, 743 (1997).
P. Quevauviller, O. F. X. Donard, J. C. Wasserman, F. M. Martin and J. Schneider, Applied Organometallic Chemistry 6, 221 (1992).
Determination of Methyl Mercury by Aqueous Phase Ethylation, Followed by Gas Chromatographic Separation with Cold Vapor Atomic Fluorescence Detection, John F. De Wild, Mark L. Olson, and Shane D. Olund, U.S. Geological Survey, Open-File Report 01-445, 2002.
Analysis Of Ultra-Trace Levels Of Methyl Mercury In Water By Aqueous Phase Ethylation, Xianchao Yu & T. M. Chandrasekhar, Florida Department Of Environmental Protection. 2003.
US EPA Method 1630, Methyl Mercury In Water By Distillation, Aqueous Ethylation, Purge And Trap And CVAFS, 2001.
Pawel Pohl, Trends in Analytical Chemistry, vol. 23, no. 2, (2004) 87.
Henryk Matusiewicz and Magdalena Krawczyk, Journal of the Brazilian Chemical Society, vol. 18, no.2(2007) 304.
Morita H.; Tanaka H.; Shimomura S. Atomic fluorescence spectrometry of mercury: principles and developments. Spectrochimica Acta Part B: Atomic Spectroscopy, Volume 50, Number 1, January 1995 , pp. 69-84(16)
U. Pyell·A. Dworschak·F. Nitschke·B. Neidhart, Flow injection electrochemical hydride generation atomic absorption spectrometry (FI-EHG-AAS) as a simple device for the speciation of inorganic arsenic and selenium, Fresenius J Anal Chem (1999) 363:495-498.
Chengbin Zheng, Yuan Li, Yihua He, Qian Ma and Xiandeng Hou, Photo-induced chemical vapor generation with formic acid for ultrasensitive atomic fluorescence spectrometric determination of mercury: potential application to mercury speciation in water, J. Anal. At. Spectrom., 2005, 20, 746-750.

What is claimed is:

1. A method for analysis of a stable and derivatizable analyte, the method comprising the steps of:
(a) contacting the analyte with a derivatizing agent to generate a volatile derivatized-analyte in a flow-through device;
(b) separation of the volatile derivatized-analyte into a gas phase;
(c) separation of the gaseous derivatized-analyte using a chromatographic method; and
(d) detection of the derivatized analyte with an appropriate detector.

2. The method of claim 1 wherein the flow-through device is a T-connector, or a Y-connector.

3. The method of claim 1 wherein the analyte comprises a mercury species, and the detector comprises an atomic fluorescence spectrometer.

4. The method of claim 3 further comprising the step of pre-concentrating the volatile species in a trapping device, prior to separation in the gas chromatograph.

5. The method of claim 4 wherein the trapping device comprises a carbo-trap or a cryotrap.

6. The method of claim 3 wherein the derivatizing agent comprises stannous chloride, sodium tetraethylborate or tetrapropylborate, sodium cyanotrihydroborate (III), sodium tetrahydroborate, or potassium tetrahydraborate.

7. The method of claim 6 wherein the derivatizing agent comprises sodium tetrahydroborate.

8. The method of claim 3 wherein the analyte comprises one or more of elemental mercury, methyl mercury, ethyl mercury, dimethyl mercury or diethyl mercury.

9. A system for analyzing a stable and derivatizable analyte, comprising:
(a) a flow-through device for combining an analyte flow and a derivatizing agent flow;
(b) a phase separator having an inlet for the combined analyte/derivatizing agent flow, a carrier gas inlet, and a carrier gas outlet, for separating volatile analyte derivatives into the carrier gas flow;
(c) a gas chromatograph (GC) adapted to receive the carrier gas flow from the phase separator, for separating volatile analyte derivatives in the carrier gas;
(d) a detector connected to the gas chromatograph for detecting a volatile analyte derivative.

10. The system of claim 9 wherein the flow-through device comprises a T-connector or a Y-connector adapted for combining the analyte flow and derivatizing agent flow.

11. The system of claim 9 further comprising means for collecting, and optionally pre-concentrating, the volatile analyte derivatives from the phase-separator, prior to separation by the gas chromatograph.

12. The system of claim 9 wherein the detector comprises an atomic fluorescence spectrometer for detecting one or more of elemental mercury, methyl mercury, ethyl mercury, dimethyl mercury or diethyl mercury, or derivatives thereof.

13. A method of analysis of inorganic or organic mercury, or both inorganic and organic mercury in a sample, the method comprising the steps of:
(a) derivatization of mercury species in a sample using a derivatizing agent in a flow-through device, to create volatile mercury derivatives;
(b) separation of the volatile mercury derivatives from the derivatization reagent-sample mixture using a carrier gas;
(c) separation of the derivatized mercury species in the carrier gas by gas chromatography; and
(d) detection of the derivatized mercury species.

14. The method of claim 13 wherein the derivatizing agent comprises stannous chloride, sodium tetraethylborate or tetrapropylborate, sodium cyanotrihydroborate (III), sodium tetrahydroborate, or potassium tetrahydraborate.

15. The method of claim 13 wherein the derivatizing agent comprises sodium tetrahydroborate.
